(19) United States
(12) Patent Application Publication
(10) Pub. No.: US 2006/0268201 A1
(43) Pub. Date: Nov. 30, 2006

(54) Liquid crystal display panel and manufacturing method thereof

(75) Inventors: Hao-Yu Chang, Jhubei City (TW); Jen-Lang Tung, Kaohsiung (TW)

Correspondence Address: BACON & THOMAS, PLLC, 625 SLATERS LANE, FOURTH FLOOR, ALEXANDRIA, VA, 22314, US

(73) Assignee: AU OPTRONICS CORP., Hsin-Chu (TW)

(21) Appl. No.: 11/235,342

(22) Filed: Sep. 27, 2005

(30) Foreign Application Priority Data
May 27, 2005 (TW) 94117554

(51) Int. Cl. G02F 1/1335

(52) U.S. Cl. 349/106

(57) ABSTRACT

A manufacturing method of a liquid crystal display (LCD) panel includes the following steps. Firstly, a first substrate and a second substrate are provided wherein the first substrate has a first pixel, a second pixel and a third pixel. Then, a color alignment film is formed on the first substrate and is positioned between the first substrate and the second substrate. The color alignment film includes a first color alignment region, a second alignment region and a third alignment region, which are respectively corresponding to the first pixel, the second pixel and the third pixel. Afterwards, the first color alignment region, the second alignment region and the third alignment region are exposed to different exposure amounts. Finally, a liquid crystal layer is disposed between the first substrate and the second substrate.

This application claims the benefit of Taiwan application Serial No. 94117554, filed May 27, 2005, the subject matter of which is incorporated herein by reference.

### BACKGROUND OF THE INVENTION

1. Field of the Invention

The invention relates in general to a liquid crystal display panel and a manufacturing method thereof, and more particularly to a liquid crystal display panel with a color alignment film and a manufacturing method thereof.

2. Description of the Related Art

Referring to FIG. 1, a diagram showing the optical transmittance of pixel components corresponding to RGB illuminators under different driving electric fields is shown. The horizontal coordinate corresponds to the electric field strength, and the vertical coordinate corresponds to the optical transmittance. The liquid crystal molecules have different degrees of refractivity and retardation towards visible light of different wave-lengths. Therefore, when driven by the same strength of electric field, the pixel components have different transparencies corresponding to RGB illuminators.

Gamma curve describes the relationship between the optical transmittance of a liquid crystal layer and the corresponding luminance perceived by the viewer. The luminance perceived by the viewer is inferred from the driving electric field strength of the liquid crystal layer. FIG. 2 is a diagram showing the Gamma curves of an LCD monitor corresponding to the relationship between the electric field and the transmittance in FIG. 1. The horizontal coordinate corresponds to color level number, while the vertical coordinate corresponds to the optical transmittance. As shown in FIG. 2, the Gamma curves for the red light, the green light and the blue light are different and not intersect. This implies that when the electric fields of the same strength are provided to the liquid crystal layer, the luminances of the red light, the green light and the blue light cannot maintain a constant ratio, and would deviate from the predetermined white balance of the LCD monitor. Consequently, bias would occur between the display colors as viewed by the viewer and the display signal as inputted.

The method to resolve the above problem can be categorized into two aspects: the circuit and the structure. In terms of structure, the typical method is to change the electric field strength applied to the liquid crystal layers of different color pixels by directly adjusting the thickness of the liquid crystal layer which is disposed inside the LCD monitor and corresponds to the display of the RGB pixels. Referring to FIG. 3, a cross-sectional view of a conventional LCD monitor is shown. In FIG. 3, a liquid crystal layer 110 is formed between a first substrate 102 and a second substrate 104. Moreover, three transparent organic layers 112R, 112G and 112B of different thicknesses corresponding to pixels of different colors are respectively disposed on the top surface of the first substrate 102, while three color filters 108R, 108G and 108B corresponding to pixels of different colors are disposed on the bottom surface of the second substrate 104. The pixel electrode 106 of the RGB pixels is disposed on the transparent organic layers 112R, 112G and 112B, and a common electrode 120 is disposed on the color filters 108R, 108G and 108B, so as to generate a driving electric field E in the liquid crystal layer 110. Besides, two alignment films 130 and 140 are respectively disposed on the surface of the common electrode 120 and that of the pixel electrode 106 for the alignment of the liquid crystal layer 110.

It is noteworthy that the transparent organic layers 112R, 112G and 112B are of different thicknesses, causing the corresponding liquid crystal layer 110 to have different thicknesses and the corresponding driving electric field to have different strengths. It can be seen from the above disclosure that by adjusting the thicknesses of the above transparent organic layers 112R, 112G and 112B, the strength of the driving electric field is changed, the alignment of the liquid crystal molecules in the liquid crystal layer 110 is adjusted, the optical transmittance of the liquid crystal layer 110 is changed, and finally the object of calibrating and separating the RGB Gamma curves is achieved.

However, the above solution still has the following disadvantages:

1. An extra manufacturing process of fabricating the transparent organic layers 112R, 112G and 112B is required prior to fabricating the pixel electrode, resulting in an increase in terms of manufacturing cost and manufacturing time.

2. The transparent organic layers 112R, 112G and 112B have different thicknesses in respective positions corresponding to the pixels of different colors, resulting in a bumpy top surface of the transparent organic layers, making it more difficult in forming the alignment film 140 on the top surface of the pixel electrode 106 in subsequent liquid crystal alignment process.

3. The pixel electrode 106 covers the bumpy top surface of the transparent organic layer 112R, 112G and 112B. Since the transparent organic layers 112R, 112G and 112B of different colors have different thicknesses, and a horizontal electric field would occur between adjacent pixel electrodes 106 of different colors, affecting the alignment of the liquid crystal molecules and the normal operation of the liquid crystal layer 110.

### SUMMARY OF THE INVENTION

It is therefore an object of the invention to provide a liquid crystal display panel and manufacturing method thereof. A color alignment film is used to replace a conventional color filter, so that alignment and color separation are achieved at the same time. At first, a second and a third color alignment regions of the color alignment film are exposed to different exposure amounts, so that the corresponding liquid crystal layer of the color alignment regions can have different transparencies, whereby the Gamma curves of a liquid crystal display (LCD) panel are calibrated accordingly.

The invention achieves the above-identified object by providing a manufacturing method of a liquid crystal display (LCD) panel. The method includes the following steps. Firstly, a first substrate and a second substrate are provided. The first substrate has a first pixel, a second pixel and a third pixel. Then, a color alignment film is formed on the first substrate and is positioned between the first substrate and the second substrate. The color alignment film includes a first color alignment region, a second alignment region and a third alignment region, which are respectively corresponding to the first pixel, the second pixel and the third pixel. Afterwards, the first color alignment region, the second alignment region and the third alignment region are exposed to different exposure amounts. Finally, a liquid crystal layer is disposed between the first substrate and the second substrate.

The invention achieves the above-identified object by further providing an LCD panel including a first substrate, a second substrate, a color alignment film and a liquid crystal layer. The first substrate disposed in parallel to the second substrate has a first pixel, a second pixel and a third pixel. The color alignment film is disposed on the first substrate and is positioned between the first substrate and the second substrate. The color alignment film includes a first color alignment region, a second color alignment region and a third color alignment region, which are respectively corresponding to the first pixel, the second pixel and the third pixel. Besides, the liquid crystal layer is disposed between the first substrate and the second substrate.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram showing the optical transmittance of pixel components corresponding to RGB illuminators under different driving electric fields;

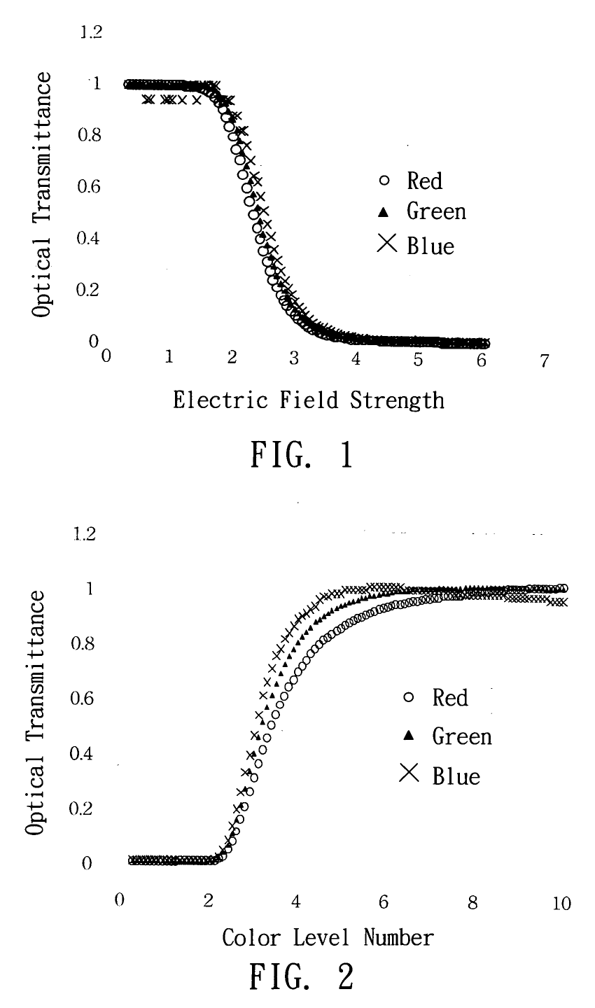

FIG. 2 is a diagram showing the Gamma curves of an LCD monitor corresponding to the relationship between the electric field and the transmittance in FIG. 1;

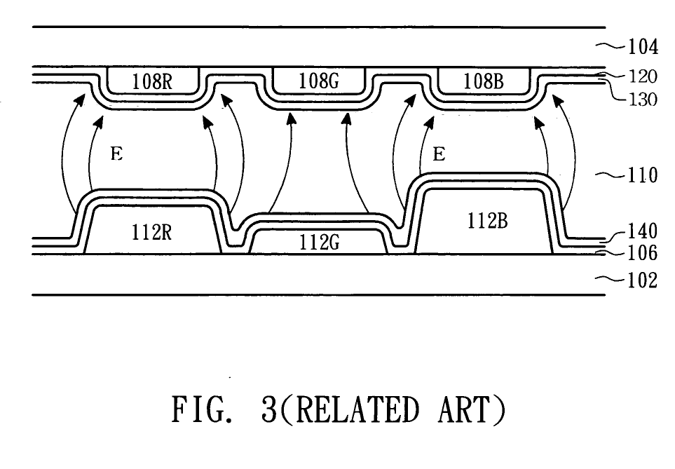

FIG. 3 (Related Art) is a cross-sectional view of a conventional LCD monitor;

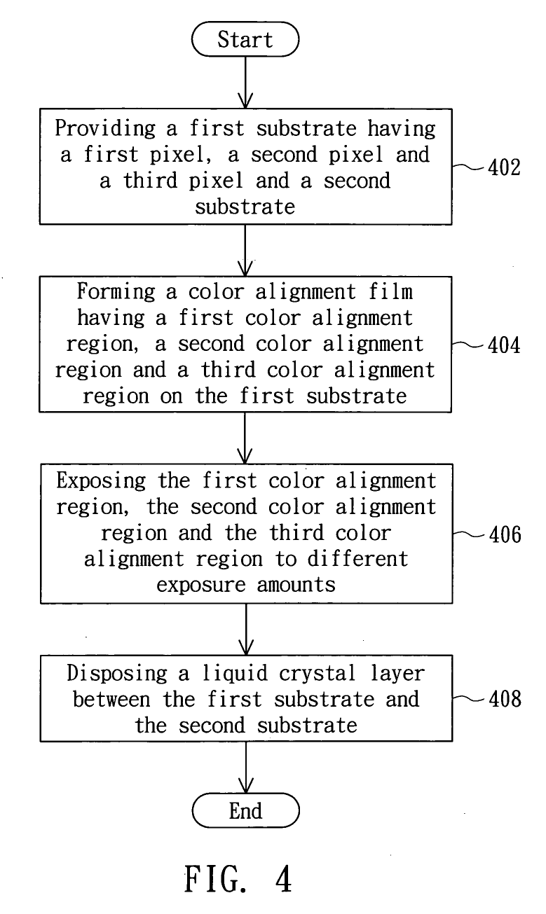

FIG. 4 is a flowchart of a manufacturing method of an LCD panel according to a preferred embodiment of the invention; and

FIG. 5A˜5D are cross-sectional views of the LCD panel according to a preferred embodiment of the invention.

### DETAILED DESCRIPTION OF THE INVENTION

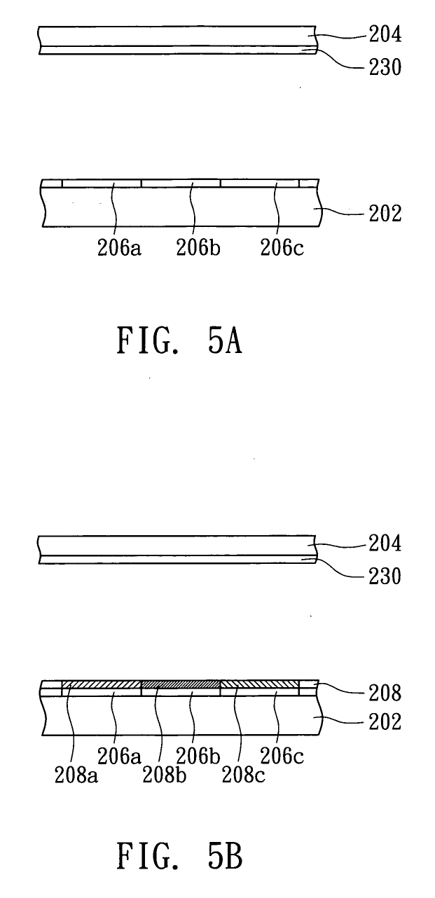

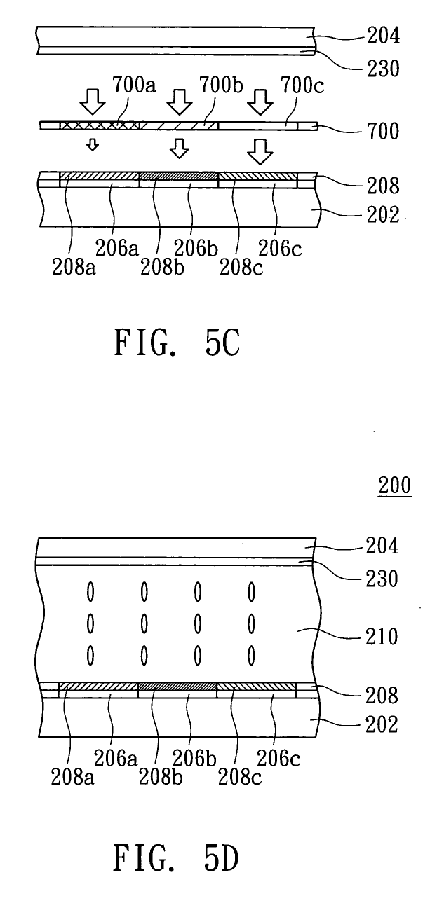

Referring to FIGS. 4˜5D, FIG. 4 is a flowchart of a manufacturing method of an LCD panel according to a preferred embodiment of the invention, and FIGS. 5A˜5D are cross-sectional views of the LCD panel according to a preferred embodiment of the invention.

At first, the method begins at step 402. A first substrate 202 and a second substrate 204 are provided as shown in FIG. 5A. If the first substrate 202 of FIG. 5A is viewed from the top, it can be seen that the first substrate 202 has a pixel array such as an active matrix for instance. The pixel array has a number of pixels. Each pixel is defined by two adjacent scan lines and two adjacent data lines. Each pixel includes a control switch and a pixel electrode. Each control switch is electrically connected to a corresponding scan line and a corresponding data line. Each pixel electrode is electrically connected to a corresponding control switch. In the present embodiment, FIG. 5A is exemplified by the first substrate 202 having a first pixel 206a, a second pixel 206b and a third pixel 206c. Besides, the first substrate 202 and the second substrate 204 are disposed in parallel to each other. The second substrate 204 has an alignment film 230 formed thereon.

Next, proceeding to step 404, a color alignment film 208 is formed on the first substrate 202 and between the first substrate 202 and the second substrate 204 by using ink-jetting, printing or coating. The ink-jetting technology can be a fixed-point disposition ink-jetting technology as shown in FIG. 5B. In FIG. 5B, the color alignment film 208 positioned between the first substrate 202 and the second substrate 204 includes a first color alignment region 208a, a second color alignment region 208b and a third color alignment region 208c, which are respectively corresponding to the first pixel 206a, the second pixel 206b and the third pixel 206c. The first color alignment region 208a, the second color alignment region 208b and the third color alignment region 208c are of different colors. For example, the first color alignment region 208a is a red (R) alignment region, the second color alignment region 208b is a green (G) alignment region, and the third color alignment region 208c is a blue (B) alignment region. The color alignment film 208 according to the present embodiment achieves both alignment and color separation, so that the second substrate 204 or the first substrate 202 can do without a color filter for separating colors, largely simplifying the manufacturing process of LCD panel. The color alignment film 208 can include a photo-alignment material, a dye or a pigment, and the alignment film 230 can be formed on the second substrate 204 in step 404.

Then, proceeding to step 406, the first color alignment region 208a, the second color alignment region 208b and the third color alignment region 208c are exposed to different exposure amounts. The step of exposing the first color alignment region 208a, the second color alignment region 208b and the third color alignment region 208c can be implemented by using a gray level mask 700 as shown in FIG. 5C. In FIG. 5C, the gray level mask 700 includes a non-transparent region 700a, a semi-transparent region 700b and a full-transparent region 700c with the non-transparent region 700a, the semi-transparent region 700b and full-transparent region 700c respectively having different transmittances and corresponding to the first color alignment region 208a, the second color alignment region 208b and the third color alignment region 208c. The required exposure amounts of the first color alignment region 208a, the second color alignment region 208b and the third color alignment region 208c are controlled according to the transmittance of various regions of the gray level mask 700.

There are a number of methods of exposing the first color alignment region 208a, the second color alignment region 208b and the third color alignment region 208c to different exposure amounts. For example, the above exposure can be achieved by providing different exposure amounts to the first color alignment region 208a, the second color alignment region 208b and the third color alignment region 208c according to the number of masks, the diversity of exposure angles, the length of exposure duration, or the intensity of exposure light source.

In terms of the number of masks used, the step 406 of exposing includes applying at least two masks. For example, the first color alignment region 208a, the second color alignment region 208b and the third color alignment region 208c can respectively have a low exposure amount, a medium exposure amounts and a high exposure amount. The step of using two masks to expose the first color alignment region 208a, the second color alignment region 208b and the third color alignment region 208c can be achieved by the following sequence: First, the first color alignment region 208a, the second color alignment region 208b and the third color alignment region 208c are exposed to the low exposure amount. Next, the mask corresponding to the second color alignment region 208b is used to expose the second color alignment region 208b to the medium exposure amount. Then, the mask corresponding to the third color alignment region 208c is used to expose the third color alignment region 208c to a high exposure amount.

In terms of exposure duration, the step 406 of exposing can be implemented by sequentially projecting an exposure light source of the same intensity onto the first color alignment region 208a, the second color alignment region 208b and the third color alignment region 208c at different exposure durations, so that the first color alignment region 208a, the second color alignment region 208b and the third color alignment region 208c are exposed to different exposure amounts. That is to say, the first color alignment region 208a, the second color alignment region 208b and the third color alignment region 208c are correspondingly exposed by the exposure light source of the same intensity at different exposure durations.

In terms of exposure angles, the step 406 of exposing can be implemented by sequentially projecting an exposure light source of the same intensity onto the first color alignment region 208a, the second color alignment region 208b and the third color alignment region 208c from different exposure angles, so that the first color alignment region 208a, the second color alignment region 208b and the third color alignment region 208c are exposed to different exposure amounts. That is to say, the first color alignment region 208a, the second color alignment region 208b and the third color alignment region 208c are correspondingly exposed by the exposure light source of the same intensity from different incident angles.

In terms of the intensity of exposure light source, the step 406 of exposing can be implemented by sequentially projecting an exposure light source of the same exposure duration and the same exposure angle onto the first color alignment region 208a, the second color alignment region 208b and the third color alignment region 208c with different intensities, so that the first color alignment region 208a, the second color alignment region 208b and the third color alignment region 208c are exposed to different exposure amounts. That is to say, the first color alignment region 208a, the second color alignment region 208b and the third color alignment region 208c are exposed by the light source with different intensities. In the present embodiment, the exposure energy of the first color alignment region 208a approximately ranges from 5 mJ/cm² to 4000 mJ/cm², the exposure energy of the second color alignment region 208b approximately ranges from 10 mJ/cm² to 4500 mJ/cm², and the exposure energy of the third color alignment region 208c approximately ranges from 15 mJ/cm² to 5000 mJ/cm². The above exposure light source can be a polarized or non-polarized ultra-velvet light.

After the first color alignment region 208a, the second color alignment region 208b and the third color alignment region 208c are exposed to have different exposure amounts, then proceeding to step 408. The first substrate 202 and the second substrate 204 are disposed in parallel through a sealant, and a liquid crystal layer 210 is disposed between the first substrate 202 and the second substrate 204, so that the liquid crystal layer 210 is positioned between the color alignment film 208 and the alignment film 203 as shown in FIG. 5D. Meanwhile, LCD panel 200 is completed.

In FIG. 5D, since the first color alignment region 208a, the second color alignment region 208b and the third color alignment region 208c receive different exposure amounts, different regions of the liquid crystal layer 210 corresponding to the first color alignment region 208a, the second color alignment region 208b and the third color alignment region 208c would have different transparencies. Consequently, the Gamma curve of LCD panel 200 can be calibrated, and the red, the green, and the blue (RGB) Gamma curves of LCD panel 200 overlap.

According to the LCD panel of the present embodiment, a color alignment film is used to replace a conventional color filter, so that alignment and color separation are achieved at the same time. At first, a second and a third color alignment regions of the color alignment film are exposed to different exposure amounts, so that the corresponding liquid crystal layer of the color alignment regions can have different transparencies, whereby the Gamma curves of a liquid crystal display (LCD) panel are calibrated accordingly, and that the LCD panel can have better display quality. The manufacturing method of the LCD panel of the present embodiment dispenses with the step of conventional color filter, so that the manufacturing process of LCD panel is simplified and that the manufacturing time and cost are both reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for manufacturing a liquid crystal display (LCD) panel, comprising:
providing a first substrate and a second substrate, wherein the first substrate has a first pixel, a second pixel and a third pixel;
forming a color alignment film on the first substrate and between the first substrate and the second substrate, wherein the color alignment film comprises a first color alignment region, a second color alignment region and a third color alignment region, which are respectively corresponding to the first pixel, the second pixel and the third pixel;
exposing the first color alignment region, the second color alignment region and the third color alignment region to different exposure amounts; and
disposing a liquid crystal layer between the first substrate and the second substrate.

2. The method according to claim 1, wherein the first color alignment region, the second color alignment region and the third color alignment region are formed by using ink-jetting, printing or coating.

3. The method according to claim 2, wherein the ink-jetting is implemented by a fixed-point disposition ink-jetting.

4. The method according to claim 1, wherein the step of exposing comprises applying a gray level mask to expose the first color alignment region, the second color alignment region and the third color alignment region.

5. The method according to claim 4, wherein the gray level mask comprises a non-transparent region, a semi-transparent region and a full-transparent region respectively corresponding to the first color alignment region, the second color alignment region and the third color alignment region.

6. The method according to claim 1, wherein the step of exposing comprises applying at least two masks to expose the first color alignment region, the second color alignment region and the third color alignment region.

7. The method according to claim 1, wherein the step of exposing comprises exposing the first color alignment region, the second color alignment region and the third color alignment region to different exposure durations.

8. The method according to claim 1, wherein the step of exposing comprises exposing the first color alignment region, the second color alignment region and the third color alignment region to exposure light sources of different incident angles correspondingly.

9. The method according to claim 1, wherein the first color alignment region is a red alignment region, and the exposure energy of the first color alignment region ranges from about 5 mJ/cm² to about 4000 mJ/cm².

10. The method according to claim 1, wherein the second color alignment region is a green alignment region, and the exposure energy of the second color alignment region ranges from about 10 mJ/cm² to about 4500 mJ/cm².

11. The method according to claim 1, wherein the third color alignment region is a blue alignment region, and the exposure energy of the third color alignment region ranges from about 15 mJ/cm² to about 5000 mJ/cM².

12. A liquid crystal display (LCD) panel, comprising:
a first substrate having a first pixel, a second pixel and a third pixel;
a second substrate opposed to the first substrate;
a color alignment film, disposed on the first substrate and positioned between the first substrate and the second substrate, comprising a first color alignment region, a second color alignment region and a third color alignment region, which are respectively corresponding to the first pixel, the second pixel and the third pixel; and
a liquid crystal layer disposed between the first substrate and the second substrate.

13. The panel according to claim 12, wherein the color alignment film comprises a material selected from the group consisting of a photo-alignment material, a dye, a pigment, and combinations thereof.

14. The panel according to claim 12, wherein the first color alignment region is a red alignment region, the second color alignment region is a green alignment region, and the third color alignment region is a blue alignment region.
